(19) United States
(12) Patent Application Publication
(10) Pub. No.: US 2013/0191247 A1
(43) Pub. Date: Jul. 25, 2013

(54) Dynamic Item-Return Guarantee

(71) Applicant: MANHEIM INVESTMENTS, INC., Atlanta, GA (US)

(72) Inventors: Grace Chu Huang, Atlanta, GA (US); Paul D. Sims, Alpharetta, GA (US); Matthew A. Trapp, Atlanta, GA (US); Greg Claud Easterly, Atlanta, GA (US); Joe George, Atlanta, GA (US); Annie Duguid, Atlanta, GA (US); Krista Marlatt, Atlanta, GA (US)

(73) Assignee: MANHEIM INVESTMENTS, INC., Atlanta, GA (US)

(21) Appl. No.: 13/747,117

(22) Filed: Jan. 22, 2013

Related U.S. Application Data
(60) Provisional application No. 61/588,474, filed on Jan. 19, 2012.
(60) Provisional application No. 61/718,041, filed on Oct. 24, 2012.

(51) Int. Cl. G06Q 30/06

(52) U.S. Cl. CPC G06Q 30/0609
USPC 705/26.35

(57) ABSTRACT

Embodiments of the present disclosure are directed to providing a dynamic, no-questions-asked, money-back, item-return guarantee for item purchases. For example, a buyer-dealer may access a marketplace platform and search for a particular item to purchase. In some aspects, next to each item for sale, a guarantee acquisition fee may be displayed. This guarantee acquisition fee may indicate the additional cost, to the buyer-dealer, to purchase a no-questions-asked, money-back, item-return guarantee from the marketplace platform. As such, if an item and its respective item-return guarantee are purchased, the buyer-dealer may return the item to the marketplace platform for a full or partial refund of the item purchase price.

### CROSS-REFERENCE TO RELATED APPLICATIONS

The present disclosure claims priority to and the benefit of U.S. Provisional Patent Application No. 61/718,041, entitled “Dynamic Item-Return Guarantee,” filed on Oct. 24, 2012, which is hereby incorporated by reference in its entirety. In addition, the present disclosure also claims priority to and the benefit of U.S. Provisional Patent Application No. 61/588,474, entitled “Dynamic Item-Return Guarantee,” filed on Jan. 19, 2012, which is hereby incorporated by reference in its entirety.

### BACKGROUND

Buyers and sellers today typically utilize some form of an online marketplace platform to sell, purchase, and/or exchange items. Buyers purchasing or exchanging items over the platform, however, may be reluctant to purchase or exchange items with unfamiliar sellers. For example, transactions between users who do not know one-another, do not trust one-another, and/or do not normally deal in the items being purchased or exchanged may be discouraged to interact due to perceived disparities in knowledge about particular items. Accordingly, there is a continuing need to provide confidence between buyers and sellers as they conduct business over the platform.

### BRIEF DESCRIPTION OF THE DRAWINGS

The detailed description is set forth with reference to the accompanying drawings. In the drawings, the left-most digit(s) of a reference numeral identifies the drawing in which the reference numeral first appears. The use of the same reference numerals may indicate similar or identical items. Various embodiments may utilize elements and/or components other than those illustrated in the drawings, and some elements and/or components may not be present in various embodiments. Throughout this disclosure, depending on the context, singular and plural terminology may be used interchangeably.

FIG. 1 depicts an illustrative architecture in which techniques for providing a dynamic, item-return guarantee may be implemented in accordance with one or more embodiments of the disclosure.

FIG. 2 depicts an illustrative architecture in which techniques for providing a dynamic guarantee acquisition fee may be implemented in accordance with one or more embodiments of the disclosure.

FIG. 3 depicts an example flow diagram showing processes for providing a guarantee platform and/or a service for providing guarantee acquisition fees in accordance with one or more embodiments of the disclosure.

FIG. 4 depicts an example flow diagram showing processes for providing a guarantee platform and/or a service for providing guarantee acquisition fees in accordance with one or more embodiments of the disclosure.

### DETAILED DESCRIPTION

### Overview

Embodiments of the present disclosure are directed to, among other things, providing a dynamic, no-questions-asked, money-back, item-return guarantee for item purchases. In some examples, the items may be purchased through a dealer-to-dealer marketplace platform that provides the items to potential buyers, sellers, dealers, traders, wholesalers, and/or retailers. Additionally, dealers, buyers, sellers, and/or other users of the platform may provide reviews and/or ratings of other dealers using the platform and/or of vehicles purchased through the platform. Further, offer and/or purchase prices of items (i.e., the final price paid for the item), buyer and/or seller activities, buyer and/or seller attributes, and/or market activity may be utilized to generate and/or provide the item-return guarantee. For example, a buyer-dealer may access the marketplace platform and search for a particular item to purchase. In some aspects, next to each item for sale, a guarantee acquisition fee may be displayed. This guarantee acquisition fee may indicate the additional cost, to the buyer-dealer, to purchase a no-questions-asked, money-back, item-return guarantee from the marketplace platform. As such, if an item and its respective item-return guarantee are purchased, the buyer-dealer may return the item to the marketplace platform for a full or partial refund of the item purchase price.

In some aspects, the guarantee acquisition fee may be based on several factors and/or combinations of factors. For example, and as noted briefly above, the offer price made by a buyer-dealer for an item and/or the final transaction price of the item may factor into the guarantee acquisition fee. That is, in some aspects, as the offer price and/or projected final transaction price of the item increases, the guarantee acquisition fee may also increase. Further, in some examples, a surcharge and/or a cap on (or percentage of) the final transaction price that may qualify for the guarantee may be included by the platform to compensate for final transaction prices that exceed market rates or that exceed potential costs if returned. Additionally, in some examples, dealers or other users of the platform may rate, rank, or otherwise provide reviews of other dealers (e.g., buyers and/or sellers) that utilize the platform. As such, these reviews and/or ratings may factor into the guarantee acquisition fee. For example, an item being sold by a seller-dealer with better ratings (e.g., an A+ seller, a 5-star seller, etc.), may garner a lower guarantee acquisition fee than an item (same or different) being sold by a seller-dealer with lower ratings (e.g., a seller with poor reviews, high return rates, negative arbitration rates, etc.).

Additionally, in some aspects, the guarantee acquisition fee may also be based, in part, on dealer activities, dealer attributes, and/or market data. For example, buying and/or selling behaviors of dealers using the platform may be logged, buying and/or selling behaviors of dealers using third-party services may be received, and/or arbitration rates, arbitration outcomes, and/or dispute patterns may be logged based on activity associated with the platform and/or received based on activity associated with third-party marketplaces, third-party arbitration services, and/or other third-party service providers. As noted above, this activity information may be utilized to generate and/or update the guarantee acquisition fee. Additionally, in some examples, dealer attributes (e.g., credit ratings, financial information, transaction information, etc.) may be received from third-party service providers and utilized to enhance the guarantee acquisition fee. For example, buyer and/or seller relationships, buyer and/or seller transaction behavior, and/or information aggregated by and/or received from other websites such as, but not limited to, transaction data from item auction sites, listing data from item listing sites, etc., may be received by the platform and factored into the guarantee acquisition fee. Further, in some examples, market activity surrounding the item that is being sold may be utilized. For example, the number of viewers, the number of interested buyer-dealers (e.g., the number of buyer-dealers that have made an offer to purchase the particular item), and/or the type, frequency, amount, and/or value of offers being made may be factored into the guarantee acquisition fee. As such, based in part on one or more of the above-mentioned factors, a risk assessment may be made for each possible transaction (i.e., sale or potential sale of an item), and the guarantee acquisition fee may be based, in part, on the risk assessment. In this way, transactions that are more risky may, in some instances, garner a greater guarantee acquisition fee.

More explicitly, a guarantee acquisition fee may be determined based on several factors including, but not limited to, item properties, buyer-dealer properties, and/or seller-dealer properties. Item properties may include, without limitation, the item condition, make, model, mileage, quality characteristics, recalls, current events (e.g., sudden accelerations, etc.), rollovers, tire explosions, etc. Buyer-dealer properties may include, without limitation, reviews, ratings, typical inventory quality (e.g., whether the buyer-dealer generally purchases good or bad quality vehicles), rates of return, etc., associated with one or more items of the buyer-dealer. Seller-dealer properties may include, without limitation, reviews, ratings, typical inventory quality, claim rates, etc., associated with one or more items of the seller-dealer. Further, in some examples, the guarantee may encourage transactions between dealers who do not know one-another, do not trust one-another, and/or may not normally deal with items of that type (to ease disparities in knowledge about particular items).

As an overview, items may be any products or services that may be sold or exchanged including, for example, and without limitation, vehicles, vehicle parts, computer products, firearms, articles of clothing, gemstones, jewelry, consumer electronics, electronics parts, yard appliances, construction machines and equipment, aircrafts, boats, office equipment, furniture, manufacturing equipment, packaging equipment, kitchen equipment, appliances, raw materials, mineral rights, water rights, combinations of the foregoing, or the like, or related products and components. While many of the embodiments of this Detailed Description are described in terms of vehicles, those of skill in the art will understand that the disclosure is not so-limited, and other products, as described herein, could be substituted for vehicles. Moreover, while many of the embodiments of this Detailed Description are described in terms of a dealer-to-dealer marketplace platform, those of skill in the art will understand that the disclosure is not so-limited, and other platforms may be substituted for the dealer-to-dealer marketplace platform. For example, other suitable platforms may include business-to-consumer marketplace platforms and/or buyer-to-seller marketplace platforms that provide the items to potential buyers (e.g., consumers and/or end-users), sellers, dealers, traders, wholesalers, and/or retailers. In this manner, the terms buyer-dealer and seller-dealer may include simply a buyer and a seller, respectively. Moreover, in some embodiments the platform through which the item is sold may be independent from the platform that generates or originates the guarantee. That is, a separate guarantee platform could be used to provide third-party or white-labeled guarantees to a variety of other platforms. Those of skill in the art will understand that the various inputs described in conjunction with the various embodiments of the guarantee and guarantee platform, which are discussed throughout this Detailed Description, could be received through another platform (e.g., an item sales platform) and delivered to the guarantee platform. Similarly, those of skill in the art will understand that in such an embodiment, the guarantee platform may generate a guarantee fee based on attributes as described herein (received from other platforms or directly through the guarantee platform). Further, in any consumer facing guarantee platform, it should be understood that the consumer may take the place of a dealer as otherwise described herein.

In some examples, and as noted above, a dealer-to-dealer marketplace platform may facilitate the sales and/or exchanges of vehicles between dealers. For example, the platform may aggregate all, or a subset of all, vehicles found in inventory at every dealer, or a subset of every dealer, within a geographic region (e.g., within various cities, counties, states/territories/provinces, the United States, or one or more other countries), a set of geographic regions, a dealer franchise, a dealer network, a group of friends, the world, etc. The vehicles and/or inventories may be received from the dealers, from dealership management systems (DMSs), or from one or more third-party services that store, collect, or otherwise manage dealer inventories.

In some examples, the platform may provide settlement services such as, but not limited to, return services, title services, shipping services, arbitration services, financing services, payment transfer services, and the like, to the dealers (e.g., the buyer) once a purchase/exchange agreement occurs. Additionally, the platform may provide functionality for completing the purchase/exchange. However, in some examples, the platform may facilitate communication between the trading parties and may not actually be involved in the transaction between the dealers. In this way, the platform may allow the dealers to communicate and/or consummate transactions outside of the platform. However, in this case, the platform may request that the dealers provide transaction information to the platform once the transaction is complete. Additionally, if the guarantee is purchased by the buyer, the platform may facilitate the return of the item. In other words, if the guarantee is purchased and the item buyer decides to return the item, the platform may receive the item from the buyer and keep the guarantee acquisition fee.

As noted above, in some examples, dealers using the platform may rate and/or review other dealers. Additionally, dealers may rate and/or review groups they have created and/or groups of which they are members. However, in some examples, the platform may generate a score or rating for the dealers and/or groups instead of, or in addition to, the user-provided ratings. For example, a dealer rating may be based on satisfaction of other dealers (e.g., the user-provided ratings) and/or content mined, scrubbed, or otherwise identified from comments and/or reviews provided by the other dealers. In some examples, the platform may generate or determine an overall rating for a dealer based on a combination of user-provided ratings (e.g., a number of stars or the like) and/or content from user-provided textual reviews. For example, the platform may determine a value associated with a textual review based at least in part on mining the textual review for key words within the textual review, the number of key words within the textual review, the tone of the textual review, the depth of the textual review, the number of filler words within the textual review, and/or the number of words with content associated with the item found within the textual review.

In some aspects, the platform may determine wholesale, retail, and/or other values for each vehicle in the platform. In some examples, a wholesale and/or retail value may be provided by the seller, a DMS service, a third-party vehicle valuation service, or it may be determined by the platform. For example, the value may be based on the condition of the vehicle, mileage, the year, the make and/or model of the vehicle, and/or market conditions, such as real-time market conditions, related to similar vehicles. Additionally, in some examples, the determined market value may be compared against the vehicle listing price and/or offers being received from potential buyers in order to generate, update, or otherwise determine the guarantee acquisition fee that may be provided by the platform.

Further, by way of example and without limitation, real-time market conditions may include conditions that are determined based on real-time, or near real-time, data. That is, data may be updated continuously over a period of time such as, but not limited to, every second, every minute, every hour, every day, every week, etc., or any appropriate interval based on the context. For example, and as those of skill in the art will understand, different contexts may create different understandings of real-time (e.g., in the new and/or used automobile market, real-time market conditions may imply market conditions that change throughout a day or even a week). Further, in some examples, item sellers may be item owners who wish to sell or exchange their items, or those with the authority to sell or exchange the items for the owners. Additionally, item buyers may be those people or entities that receive items, new or used, in exchange for either money (or its equivalent) or other items. Generally, but not always, the item buyer may intend, or attempt, to resell the item that was received.

Further, in some examples, the platform may provide guarantees and/or guarantee acquisition fees to third-party wholesalers, third-party retailers, third-party auctions, third-party websites, and/or other third-party service providers. As such, the information collected and/or utilized to determine the guarantee amounts, the surcharge, the guarantee caps, and/or the guarantee acquisition fees may be received by the platform from one or more third-party service providers. Based on this information, the platform may then determine the appropriate guarantee amounts and/or fees and then provide these amounts and/or fees to the third-party service providers for use within their own third-party systems. For example, and without limitation, a third-party auction company may provide vehicle and/or dealer information to the platform. The platform may generate a guarantee amount and/or a guarantee acquisition fee for the purchase of the vehicle to one or more dealers. Finally, the platform may provide the amount and/or the fee to the third-party service provider. The third-party service provider may then modify, revise, or otherwise utilize the amounts and/or fees in conjunction with a sale or trade of a vehicle through a live, simulcast, online, or other auction.

In an additional embodiment, the systems and methods described herein to determine the guarantee acquisition fee may also be at least partially implemented to determine an offer price for a vehicle. That is, an offer price for a vehicle may be determined and presented to a seller through the marketplace platform or elsewhere. The offer price may comprise, for example, the price the marketplace itself (or an agent thereof) is willing to purchase a vehicle for and/or an amount of money the marketplace is willing to provide (i.e., “front” or “advance”) the seller prior to selling the vehicle. In this manner, the seller may elect to redeem the offer price, and the marketplace may “buy” the vehicle and/or take possession of the vehicle for later sale without actually purchasing the vehicle (i.e., bailment). For example, a seller may access the marketplace platform and identify a vehicle for sale. An offer price for the vehicle may be determined by the marketplace. In some aspects, next to each vehicle for sale, the offer price may be displayed or otherwise presented to the seller in another manner. The offer price may be determined based on any of the factors or combinations thereof described herein for determining the guarantee acquisition fee.

In some aspects, if the offer price is accepted by the seller, the marketplace (or an agent thereof) may outright purchase the vehicle. In this case, the marketplace may make the appropriate arrangements for inspecting, transporting, and/or selling the vehicle. In other aspects, if the offer price is accepted by the seller, the marketplace (or an agent thereof) may enter a bailment-type relationship with the seller, wherein the marketplace takes possession of the vehicle without actually acquiring title to the vehicle and advances the seller money prior to selling the vehicle. Again, the marketplace may make the appropriate arrangements for inspecting, transporting, and/or selling the vehicle at auction or elsewhere. In some instances, however, the marketplace may never take possession of the vehicle.

In certain instances, the seller may have some portion of the offer price held-back such that if the vehicle underperforms when sold (e.g., at auction or elsewhere), the seller may receive a smaller amount of the offer price. Conversely, if the vehicles over performs (e.g., sells for a greater price at auction), the seller may receive additional money.

In some aspects, the offer price may be based on several factors and/or combinations of factors. For example, the offer price may be based at least in part on the projected (or predicted) sales price of the vehicle at auction or elsewhere. In this manner, the offer price may comprise a percentage (such as 92%, 87%, 60% or the like) of the predicted sales price of the vehicle at auction. Additionally, the offer price may be determined based on one or more vehicles properties as indicated by the seller or received from one or more third-party service providers. Vehicle properties may include, without limitation, the vehicle condition, make, model, mileage, VIN, features, options, trims, quality characteristics, recalls, current events (e.g., sudden accelerations, etc.), rollovers, tire explosions, etc. Moreover, in some examples, market activity surrounding the vehicle or similar vehicles that are being sold may be utilized. For example, the vehicle history report of the vehicle may be used as a factor to determine the offer price and/or sales prices of related vehicles may be used to determine the offer price. Further, the actual or predicted costs associated with inspecting, transporting, reconditioning, and/or selling the vehicle at auction may be used as a factor to determine the offer price.

In some aspects, the offer price may also be based at least in part on seller properties. Seller properties may include, without limitation, reviews, ratings, typical vehicle quality, claim rates, etc., associated with one or more vehicles of the seller and/or past transactions with the seller. For example, a vehicle being sold by a seller with better ratings (e.g., an A+ seller, a 5-star seller, etc.) may garner a higher offer price than an vehicle (same or different) being sold by a seller with lower ratings (e.g., a seller with poor reviews, high return rates, negative arbitration rates, etc.). Additionally, in some examples, seller attributes (e.g., credit ratings, financial information, transaction information, etc.) may be received from third-party service providers and utilized to evaluate the offer price. As such, based in part on one or more of the above-mentioned factors, a risk assessment may be made for each possible transaction (i.e., purchase and sale of the vehicle), and the offer price may be based, in part, on the risk assessment. In this way, transactions that are more risky may, in some instances, garner a lower offer price.

This brief introduction, including section titles and corresponding summaries, is provided for the reader's convenience and is not intended to limit the scope of the claims, nor the proceeding sections. Furthermore, the techniques described above and below may be implemented in a number of ways and in a number of contexts. Several example implementations and contexts are provided with reference to the following figures, as described below in more detail. However, the following implementations and contexts are but a few of many.

### Illustrative Architecture

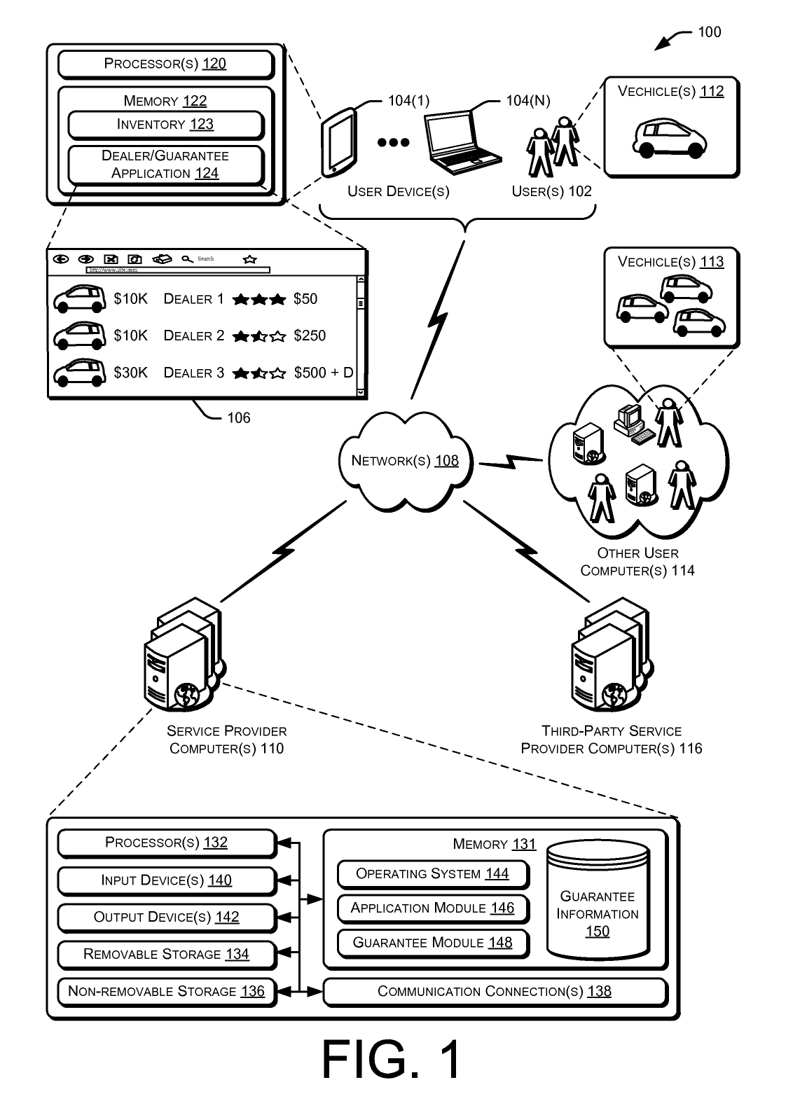

FIG. 1 depicts an illustrative architecture 100 in which techniques for providing a dynamic, item-return guarantee may be implemented. In architecture 100, one or more users 102 (e.g., vehicle dealers) may utilize computing devices 104(1), . . . , 104(N) to access a client application interface (or website) 106 that may be provided by, created by, or otherwise associated with a service provider via one or more networks 108. In some instances, the computing devices (collectively 104) may be configured to present or otherwise display the client application interface 106 to the one or more users 102. The networks 108 may include any one or a combination of multiple different types of networks, such as cable networks, the Internet, wireless networks, and other private and/or public networks. While the illustrated example represents users 102 (e.g., dealers) accessing the client application interface 106 over the networks 108, the described techniques may equally apply in instances where the users 102 interact with a service provider via a personal computer, over the phone, via a kiosk, or in any other manner. It is also noted that the described techniques may apply in other client/server arrangements (e.g., set-top boxes, etc.), as well as in non-client/server arrangements (e.g., locally stored software applications, etc.).

In some aspects, the client application interface 106 may allow the users 102 to access, receive from, transmit to, or otherwise interact with the service provider via one or more service provider computers 110. In some examples, the client application interface 106 may also allow users to receive, from the service provider computers 110 over the networks 108, information associated with one or more vehicles 112 in an inventory of a user 102 including, but not limited to, the make, the model, the color, the mileage, the vehicle identification number (VIN), condition, trim, etc. Through the client application interface 106, the user 102 may provide information associated with a vehicle 112 that the user 102 would like to sell, exchange, or purchase. Additionally, through the client application interface 106, the user 102 may also be able to search for other vehicles 113 that may be offered for sale by other dealers associated with other user computers 114. Further, in some examples, information about vehicles 112 or 113 that are for sale may be provided to the service provider computers 110 by third-party providers such as, but not limited to, DMSs, other inventory management systems, other inventory data feeds, and/or the other user computers 114.

The service provider computers 110 may be any type of computing devices such as, but not limited to, mobile, desktop, and/or cloud computing devices, such as servers. In some examples, the service provider computers 110 may be in communication with the user devices 104 via the networks 108, or via other network connections. The service provider computers 110 may include one or more servers, perhaps arranged in a cluster, as a server farm, or as individual servers not associated with one another. These servers may be configured to host a website viewable via the client application interface 106 or any other Web browser accessible by a user 102 such as, but not limited to, one or more of the user devices 104.

The architecture 100 may also include one or more other vehicle dealers operating one or more other user computing devices 114 and/or selling (or trading) one or more vehicles 113, such as at a used and/or new car lot. The dealer computing devices 114 may also be any type of computing devices such as, but not limited to, mobile, desktop, and/or cloud computing devices, such as servers. In some examples, the dealer computers 114 may be in communication with the service provider computers 110 and/or the user devices 104 via the networks 108, or via other network connections. In some examples, the dealer computer 114 may be one or more user devices 104. As such, it will be understood by those of ordinary skill in the art that the user 102 may be a dealer 114. The dealer computers 114 may include one or more servers, perhaps arranged in a cluster, as a server farm, or as individual servers not associated with one another. These servers may be configured to provide information associated with the vehicles 113 to the service provider computers 110.

The user devices 104 may be any type of computing devices including, but not limited to, desktop personal computers (PCs), laptop PCs, mobile phones, smart phones, personal digital assistants (PDAs), tablet PCs, game consoles, set-top boxes, wearable computers, e-readers, web-enabled TVs, cloud-enabled devices and work stations, and the like. In some instances and as illustrated, each user device 104 may be equipped with one or more processors 120 and memory 122 to store applications and data, such as inventory 123 and/or a dealer/guarantee application 124 that may display the client application interface 106 and/or enable access to the website 106 stored on the service provider computers 110, or elsewhere.

In some aspects, and upon request of a user 102, the client application interface 106 may display one or more vehicles, as search results, in a list, group, or other display design. That is, in some examples, when a user 102 is looking to purchase a vehicle through the service provider computers 110, the user 102 may enter a vehicle type or other parameter to begin a search. As shown in FIG. 1, in some examples, the client application interface 106 may display several vehicles associated with one or more (and sometimes different) dealers. For example, three vehicles of a particular make and model may match the search parameters entered by the user 102 and may be displayed in a list or other record. The list or record may include information associated with each vehicle adjacent to or otherwise near a link to an image of the vehicle. In some examples, the information may include the asking/offer price, the dealer's name, a dealer rating, a guarantee acquisition fee, and/or a surcharge (when appropriate).

In the example shown in FIG. 1, the first vehicle may be offered for sale by “Dealer 1” at a price of $10,000. Alternatively, the $10,000 price may correspond to the most recent (or highest) offer from one or more buyers (e.g., in an auction, exchange marketplace, bazaar, or the like). Additionally, the client application interface 106 indicates that Dealer 1 has a star rating of three stars (in this example, the star rating is shown as a scale of stars out of three stars; however, in other examples, the star rating could use more or less stars, could use other icons/images other than stars, and/or could indicate an overall rating not based on a scale at all) and that the guarantee acquisition fee for returning this vehicle is $50. Similarly, the second vehicle may also be offered for sale by “Dealer 2” for $10,000; however, Dealer 2's star rating is only 1.5 stars. As such, the guarantee acquisition fee for this transaction is displayed as $250. Further, the third vehicle may be offered for sale by “Dealer 3” for $30,000. Additionally, Dealer 3's rating may also be 1.5 stars. As such, the guarantee acquisition fee is displayed as $500 and, in addition, an additional fee, “D,” may be included. That is, when appropriate, an additional fee may be displayed to indicate that additional money may be requested from the buyer-dealer if and/or when the buyer-dealer decides to purchase the vehicle and the guarantee. In some examples, the additional fee, “D,” may include, but is not limited to, a surcharge, a percentage of the purchase price, or a cap on the purchase price, above which the buyer-dealer, the seller-dealer, and/or or a third-party guarantor may be requested to pay.

In some aspects, one of the dealers (the buyer, the seller, or both) may pay the guarantee acquisition fee upfront upon purchasing a vehicle. Then, if there is a claim (i.e., the buyer-dealer chooses to return the vehicle), and the purchase price is not fully guaranteed without a surcharge, the buyer-dealer may be requested to pay an additional fee equal to the surcharge. Additionally, in some examples, when the purchase price exceeds a reasonable guarantee amount, the guarantee acquisition fee may start rising lockstep with the purchase price over the guarantee amount. Further, in some examples, the cap may indicate the maximum purchase price that will be guaranteed by the platform (e.g., when the guarantee acquisition fee is paid). In this way, if the buyer-dealer chooses to purchase the vehicle for an amount greater than the cap, the buyer-dealer, the seller-dealer, and/or a third-party guarantor may pay all or a portion of the amount above the cap. In other words, in some examples, the guarantee acquisition fee may only provide a guarantee for the vehicle at the capped amount.

As noted above, several factors may be included in determining an overall rating of each dealer including, but not limited to, the offer/listing price for the vehicle. In addition, the overall rating, along with several other factors, may be utilized to determine a risk factor and/or the guarantee acquisition fee (and/or surcharge). As such, one of ordinary skill in the art should be able to see how the guarantee acquisition fee may change in the above example for the same make, model, and/or condition of the vehicle. That is, assuming a market value of roughly $10,000 for all three vehicles, the guarantee acquisition fee may be lower for Dealer 1 than for Dealer 2 based, in part, on the rating (e.g., if all other factors are equal, a lower rating may garner a higher guarantee acquisition fee). However, if the offer (or final transaction) price is $30,000, which in this example is well above the market value, the guarantee acquisition fee may be significantly higher, even when the ratings are the same (as seen between Dealer 2 and Dealer 3). In this example, if all other factors are equal, a higher vehicle price may garner a higher guarantee acquisition fee. Additionally, in some examples, a surcharge price may be requested from the buyer to compensate for any value above the market value that may not be recouped if the vehicle is returned. For example, here, the surcharge may be $20,000 to signify that the buyer is offering and/or purchasing the vehicle for $20,000 more than the market value. However, in other examples the surcharge may be any value and may or may not even be based on the market value of the vehicle. Additionally, in some examples, dealer ratings may not be displayed on the client application interface 106. Instead, the guarantee acquisition fee (whether higher or lower for different dealers) may indicate the overall rating of the dealer in question.

In some examples, the vehicle listing may include a wholesale and/or retail price next to, or otherwise adjacent to, each vehicle listed. The wholesale and/or retail value may be determined by the service provider computers 110 and may be based at least in part on market information including, but not limited to, location, current exchange values, the demand for the particular vehicle at the time of the listing, etc., and/or on condition, mileage, age, make, features/components, and/or model information associated with the vehicle 112. However, in some examples, the retail value may be predetermined and/or set by the seller, may be understood from the seller's asking price, and/or may also be received from a DMS associated with the seller. Additionally, in examples of other items (e.g., used digital cameras) that may be listed via the client application interface 106, market information may be determined based at least in part on the location of the camera, exchange values in particular locations, demand for the particular camera, condition, number of megapixels, brand, model, and/or other information associated with the camera.

Additionally, in an example of another type of item (e.g., jewelry) that may be listed by the client application interface 106, market information may be received by and/or determined based on information associated with any number or type of sources. For example, jewelry market information may be received by and/or otherwise determined based, in part, on jewelry publications, websites, dealer shows or exhibitions, reference guides, known estimates for particular weights, types, clarifies and/or conditions of stones, etc. As such, in some examples, wholesale and/or retails values may be based at least in part on this real-time market information. Further, one of skill in the art will understand that other factors may be involved for other items that may be listed through the services described herein, and that any type of item may be listed utilizing the disclosed services.

The architecture 100 may also include one or more third-party services operating one or more third-party service provider computers 116. The third-party service provider computers 116 may also be any type of computing devices such as, but not limited to, mobile, desktop, and/or cloud computing devices, such as servers. In some examples, the third-party service provider computers 116 may be in communication with the service provider computers 110 and/or the user devices 104 via the networks 108, or via other network connections. The third-party service provider computers 116 may include one or more servers, perhaps arranged in a cluster, as a server farm, or as individual servers not associated with one another. These servers may be configured to provide information associated with the vehicles 112 or 113, or associated with the one or more dealers 102 or other dealers 114.

In some aspects, the third-party services may include, but are not limited to, item appraisal services, item auction services, arbitration services, item listing services, item information aggregation services (e.g., services that determine market values for items based on aggregated information associated with those items), financial institutions, credit institutions, vehicle auction companies, and the like. As such, when requested by the service provider computers 110, the third-party service provider computers 116 may provide vehicle and/or dealer information. In some examples, this information may be utilized by the service provider computers 110 to determine a risk factor profile and/or a respective guarantee acquisition fee. For example, dealer activity information (e.g., buying/selling behavior, arbitration rates/outcomes, etc.), market values (e.g., retail and/or wholesale values associated with similar items in the market), dealer attributes (e.g., buyer/seller relationships, transaction behavior, etc.), and/or market activity (e.g., item bidding amounts, item bidding frequency and/or timing, overall interest, etc.) may be received from one or more third-party service provider computers 116. Further, in some examples, the third-party service computers 116 may request guarantee amounts and/or guarantee acquisition fees from the service provider computers 110 for vehicle purchase/trade transactions facilitated by or otherwise associated with the third-party services. That is, a third party service may operate a vehicle auction and wish to provide guarantees with guarantee acquisition fees to its customers without determining these values itself. As such, the service provider and/or platform may be able to provide these values to the third-party services, in some examples for an additional fee.

In some aspects, one or more servers, perhaps arranged in a cluster or as a server farm, may host the service provider 110. Other server architectures may also be used to host the service provider 110. The service provider computers 110 are capable of handling requests from many users 102 and serving, in response, various listings, messages, advertisements, and/or user interfaces that can be rendered at user devices 104.

In one illustrative configuration, the service provider computers 110 comprise at least a memory 131 and one or more processing units (or processor(s)) 132. The processor(s) 132 may be implemented as appropriate in hardware, software, firmware, or combinations thereof. Software or firmware implementations of the processor(s) 132 may include computer-executable or machine-executable instructions written in any suitable programming language to perform the various functions described.

Memory 131 may store program instructions that are loadable and executable on the processor(s) 132, as well as data generated during the execution of these programs. Depending on the configuration and type of service provider computer 110, memory 131 may be volatile (such as random access memory (RAM)) and/or non-volatile (such as read-only memory (ROM), flash memory, etc.). The service provider computer 110 or server may also include additional removable storage 134 and/or non-removable storage 136 including, but not limited to, magnetic storage, optical disks, and/or tape storage. The disk drives and their associated computer-readable media may provide non-volatile storage of computer-readable instructions, data structures, program modules, and other data for the computing devices. In some implementations, the memory 131 may include multiple different types of memory, such as static random access memory (SRAM), dynamic random access memory (DRAM), or ROM.

The memory 131, the removable storage 134, and the non-removable storage 136 are all examples of computer-readable storage media. For example, computer-readable storage media may include volatile and non-volatile, removable and non-removable media implemented in any method or technology for storage of information such as computer-readable instructions, data structures, program modules, or other data. Memory 131, removable storage 134, and non-removable storage 136 are all examples of computer storage media. Additional types of computer storage media that may be present include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile discs (DVD) or other optical storage, magnetic cassettes, magnetic tape, magnetic disk storage or other magnetic storage devices, or any other medium which can be used to store the desired information and which can be accessed by the service provider computer 110 or other computing devices. Combinations of the any of the above should also be included within the scope of computer-readable media.

Alternatively, computer-readable communication media may include computer-readable instructions, program modules, or other data transmitted within a data signal, such as a carrier wave, or other transmission. However, as used herein, computer-readable storage media does not include computer-readable communication media.

The service provider computer 110 may also contain communication connection(s) 138 that allow the service provider computer 110 to communicate with a stored database, another computing device or server, user terminals, and/or other devices on a network. The service provider computer 110 may also include input device(s) 140 such as a keyboard, mouse, pen, voice input device, touch input device, etc., and output device(s) 142, such as a display, speakers, printers, etc.

Turning to the contents of the memory 131 in more detail, the memory 131 may include an operating system 144 and one or more application programs or services for implementing the features disclosed herein including an application module 146, a guarantee module 148, and/or a guarantee information datastore 150. The application module 146 may be configured to receive, store, determine, and/or provide information associated with one or more vehicles 112 or 113 and/or one or more dealers 102 or 114. For example, the application module 146 may pull, request, scrub, mine, or otherwise collect vehicle information from one or more of the dealer computers 104 (e.g., the user devices 104), one or more other dealer computers 114, a DMS, and/or a data feed. In some aspects, the vehicle information may include a VIN number, a make, a model, a year, a condition, a color, a trim, a value, a mileage, an image, a recording, a video, a location, a seller, an inventory identifier, an amount of time the vehicle has been in a particular inventory, and/or an amount of time the vehicle has been available for exchange, trade, and/or sale. The guarantee module 148 may be configured to receive information from the application module 146 and determine and/or provide guarantee acquisition fees for purchase by item buyers. The guarantee information datastore 150 may store information associated with one or more vehicles 112 or 113 and information associated with vehicle market price, dealer activity, dealer ratings, dealer attributes, and/or market activity. For example, the guarantee information datastore 150 may include information associated with every vehicle in a first inventory and every vehicle in a second inventory, and each inventory may be associated with a different user 102 or the dealer 114. Further, the guarantee information datastore 150 may be configured to store an index, a chart, a table, or other data structure for associating particular vehicle and/or dealer (e.g., buyer or seller) information with each vehicle stored in the datastore 150.

In some aspects, the application module 146 may be configured to receive information associated with one or more vehicles and/or one or more dealers. The vehicle information may be received from the dealer devices 104, from an affiliate or associate, from a DMS, from one or more third-party service provider computers 116, and/or from one or more other dealer computers 114. The application module 146 may also receive, from a dealer (e.g., the user 102, an affiliate of the user 102, or an associate of the user 102), an indication of a rating associated with another dealer. In some aspects, the indication of a rating may include a rating on a scale (e.g., a number of stars, cars, or other symbol) or a textual review (e.g., a sentence or paragraph to describe the dealer or a transaction with the dealer). Alternatively, or in addition, the application module 146 may be configured to determine an overall rating for each first dealer. That is, in some cases, the application module 146 may determine an overall rating for a dealer based on a combination of scale ratings and/or information mined from the textual reviews (e.g., breadth of rating, length of comments, key words, blank spaces, etc.). Further, the overall rating may also include ratings that are based on a hybrid of ratings over several distinct categories (e.g., condition as represented by the seller-dealer, asking and/or purchase price of the vehicle, responsiveness of the dealer, etc.).

Further, in some aspects, the application module 146 may receive market data associated with particular vehicles. As noted above, the application module 146 may also receive, from third-party service providers, rating information from other websites associated with dealers utilizing the application module 146, dealer activity information, and/or dealer attributes. Additionally, the application module 146 may collect information associated with market activity surrounding particular transactions for particular vehicles, transactions between particular dealers, and/or information associated with particular dealer/vehicle pairs (e.g., information associated with a particular sale of a particular vehicle from a particular dealer). For example, a dealer and a VIN number may be paired together for a transaction, including offering the vehicle, associated with the VIN number, for sale. As such, the application module 146 may then collect information associated with this particular transaction.

In some aspects, the guarantee module 148 may request, receive, or otherwise retrieve the information collected by the application module 146. Once collected, the guarantee module 148 may generate or determine a risk profile for each transaction. The risk profile may then be utilized to determine a guarantee acquisition fee for guaranteeing the transaction. Other factors that may be utilized to determine the guarantee acquisition fee include, but are not limited to, vehicle properties, buyer-dealer properties, and/or seller-dealer properties. Vehicle properties may include, without limitation, the vehicle condition, make, model, mileage, quality characteristics, recalls, current events (e.g., sudden accelerations, etc.), rollovers, tire explosions, etc. Buyer-dealer properties may include, without limitation, reviews, ratings, typical inventory quality (e.g., whether the buyer-dealer generally purchases good or bad quality vehicles), rates of return, etc., associated with one or more vehicles of the buyer-dealer. Seller-dealer properties may include, without limitation, reviews, ratings, typical inventory quality, claim rates, etc., associated with one or more vehicles of the seller-dealer. For example, if Dealer 1 provides a vehicle for sale and Dealers 2, 3, and 4 each make separate offers to purchase the vehicle from Dealer 1, the guarantee module 148 may determine respective risk profiles for each transaction. In some aspects, the risk profile may be determined based on the purchase offers of each of Dealers 2, 3, or 4. In some aspects, the risk profile may be determined based on the market value of the vehicle. Further, in some aspects, the risk profile may be determined based on the received and/or determined dealer ratings of Dealers 2, 3, or 4; dealer attributes associated with Dealers 2, 3, or 4; and/or market activity associated with each offer and/or transaction. Still, in other aspects, any one or more of the above-referenced factors may be combined to determine a risk profile for each transaction.

Based at least in part on the risk profile for each transaction, the guarantee module 148 may determine and/or provide a guarantee acquisition fee which may be different for each transaction and/or dealer pairing. For example, the guarantee acquisition fee provided to Dealer 2 may be different than the guarantee acquisition fee provided to Dealer 3, even if both Dealers 2 and 3 offer the same amount for the same vehicle to the same seller (Dealer 1 in this example). In some cases, if the buyer-dealer purchases the vehicle, the buyer-dealer may choose to also purchase the guarantee. For example, if Dealer 2's offer is accepted by Dealer 1, Dealer 2 may choose to also purchase the guarantee from the service provider 110. If Dealer 2 purchases the guarantee, Dealer 2 may then later choose to return the vehicle. In this case, the service provider 110 may purchase the vehicle from Dealer 2 at the purchase price, a predetermined portion of the purchase price, the guarantee amount, and/or the capped guarantee amount, (i.e., a predetermined portion of the price of the offer that Dealer 1 accepted from Dealer 2).

As noted above, in some aspects, the application module 146 may receive inventory information from the dealer computers 114, from the user devices 104, or from a DMS or data feed. However, in other examples, the application module 146 may receive inventory information from a retail vehicle exchange service, a wholesale vehicle exchange service, a commercial vehicle exchange service, a financial institution, or a vehicle listing service. Additionally, a price or value of the vehicle may be received with the information, stored and/or provided to a user 102. Thus, the price and/or value may depend on the type of service from which the information was received. For example, if the inventory information is received from a retail exchange service, the price and/or value may be a retail value assigned to the vehicle. However, in other examples, the price and/or value of the vehicle may be independent of the information source, determined by the application module 146 based on market information for similar vehicles, based on a value provided by a third-party, and/or based on a wholesale value.

In some examples, the application module 146 may be configured to provide functionality for users 102 to rate and/or review other users (e.g., dealers). Additionally, key words may be mined from the reviews to generate more quantitative ratings and/or scores. This user rating may be a part, in some examples, of the overall rating mentioned above. For example, an aggregated score (or a “thumb score” which may be signified by a “thumb” icon) may be generated based at least in part on the user rating. For example, if a dealer gets a “thumbs up” rating from a user 102, this may increase its “thumb score” (i.e., aggregated score), while a “thumbs down” rating may decrease its “thumb score.” Other factors that may be included in a “thumb score” include, but are not limited to, vehicle ratings associated with the dealer, transaction ratings (e.g., ratings and/or reviews directed at a completed or attempted transaction such as, but not limited to, selling or trading a vehicle), activity scores (e.g., how much activity occurs on the dealer's account or behalf), a number of transactions conducted or completed, a number of positive or negative comments provided or received, a number of hyperlinks provided, a number of hyperlinks visited, a number of groups created, a number of groups included in the application module 146, and/or a value provided to the group. Additionally, in some aspects, the thumb score may be provided or be presented next to the vehicle information via the interface 106.

As noted above, the application module 146 may receive and/or aggregate information associated with multiple vehicles and/or multiple dealers. In some examples, a user 102 may then enter a search query into a search field of the application module 146 to request a list of vehicles from the aggregated information that matches the search query. In response to the search request, the application module 146 may conduct a search of the aggregated information and return a list of vehicles with associated vehicle information, icons (e.g., a “thumb score,” a meter, a group indicator, etc.), and/or vehicle values. Further, the application module 146 may also be configured to receive a filter and/or a ranking parameter for filtering and/or ranking the search results. For example, a filter parameter or a ranking parameter may include a dealer identifier, an associate identifier, a guarantee acquisition fee, a location, a vehicle type, a vehicle make, a vehicle model, a vehicle color, a vehicle mileage, and/or a vehicle condition. That is, the search results may be refined, filtered, and/or ranked based on any one or a combination of these parameters. Additionally, in some examples, the filtering and/or ranking parameters may be weighted such that some parameters have more influence on the filtering and/or ranking.

As noted above, a list of search results may include an indication of the guarantee acquisition fee that is determined for the vehicle and/or transaction (if any). In some aspects, next to or associated with the search results, the application module 146 may also present an indication of how long the vehicle has been in inventory. The indication may be a number (e.g., a number of days), or it may be an icon that represents time in some way such as, but not limited to, an icon, a color, an image, a video, a chart, or a graph. Alternatively, or in addition, the indication of how long the vehicle has been in inventory may, by way of example, only be displayed once the length of time has passed beyond a predefined time. Additionally, each predefined time period may be defined by the seller. Further, in some examples, proxy bids and/or offers may be placed on vehicles by users 102 even when not logged in. In some aspects, the proxy offer may be placed on vehicles that drop below a certain price, are listed longer than the predetermined time, and/or have a guarantee acquisition fee below a predefined value.

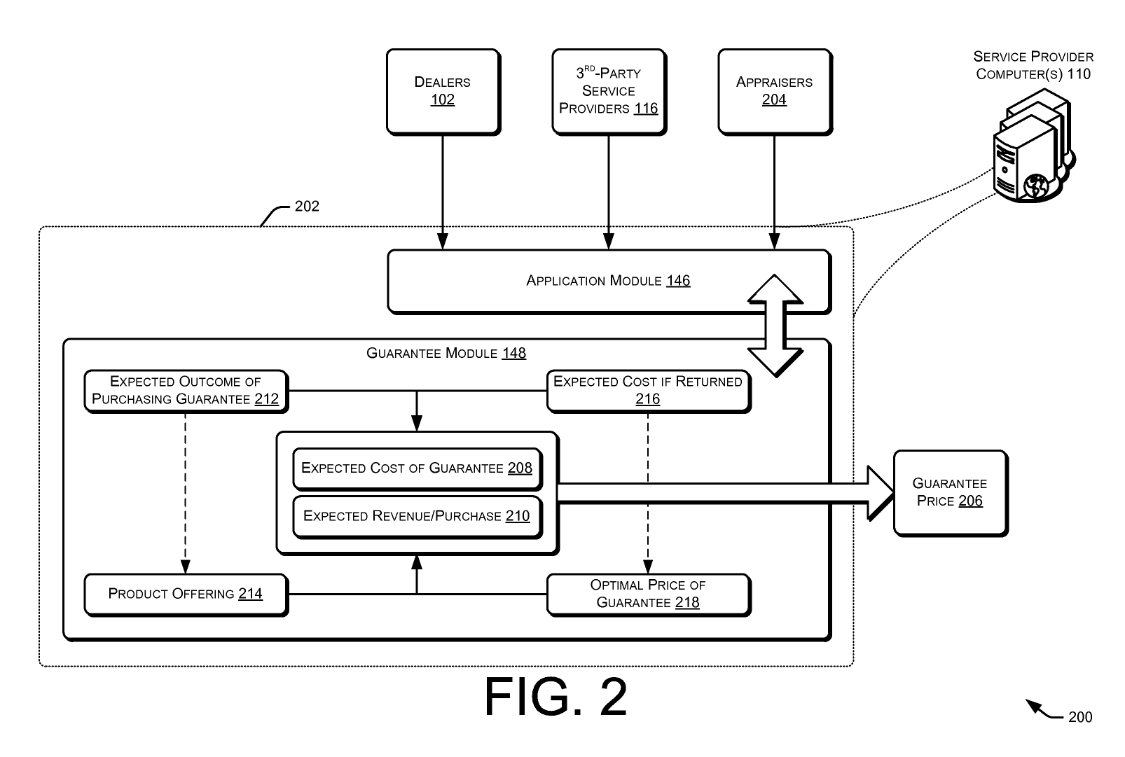

FIG. 2 depicts an illustrative architecture 200 in which additional techniques for providing a dynamic guarantee acquisition fee may be implemented. In architecture 200, the service provider computer 110 is shown again and, similar to FIG. 1, may be in communication with one or more other computers via a network. In some examples, as seen by the short-dashed box and lines, the service provider computer 110 may be configured to implement a website, such as the guarantee platform 202 of FIG. 2, and also as shown provided by the dealer/guarantee application 124 of FIG. 1, that may interact with one or more dealers 102, third-party service providers 116, and/or one or more appraisers 204. The guarantee platform 202 may be configured to perform and/or facilitate the functionalities described above with respect to the application module 146 of FIG. 1.

In some examples, vehicles and/or dealer information may be provided, requested, or otherwise received by the guarantee platform 202 by at least one of dealers 102, third-party service providers 116, or appraisers 204. That is, and as described above, vehicle and/or dealer information from multiple different sources may be aggregated by the guarantee platform 202. Here, the platform 202 may receive vehicle and/or dealer information from one or more dealers 102, and in some examples, directly from the dealer's 102 local inventory management system. Alternatively, however, inventory information may be received from the dealer 102 via a DMS that the dealer 102 regularly updates. Additionally, the platform 202 may also receive vehicle and/or dealer information from one or more third-party (or commercial) service providers 116 such as, but not limited to, financial institutions, rental car companies, credit card companies, and the like. Further, in some examples, the platform 202 may also receive vehicle information from one or more appraisers.

As noted above, in some aspects, the guarantee platform 202 may be configured to provide communication channels to dealers. For example, the platform 202 may facilitate offers, counter-offers, and general conversations about purchasing and/or trading vehicles with other dealers that are members of the service provided by the service provider computers 110. Additionally, the platform 202 may be configured to provide a guarantee acquisition fee 206 to potential buyers or dealers interested in making offers. Further, as shown in FIG. 1, the platform 202 may include an application module 146 for providing the website to dealers and/or receiving information from the appropriate sources. The platform 202 may also include a guarantee module 148 for determining the guarantee acquisition fee 206 to be provided to the dealers. While the guarantee acquisition fee 206 may be shown in FIG. 2 as being provided by the guarantee module 148, in some examples and, as should be obvious to one of ordinary skill in the art, the guarantee acquisition fee 206 may actually be transmitted from the guarantee module 148 to the application module 146. In this example, the guarantee acquisition fee 206 may be provided to the dealers by the application module 146 rather than by the guarantee module 148.

In some examples, the guarantee module 148 may be configured to determine the guarantee acquisition fee 206 based on factoring, comparing, or otherwise weighing the difference between the expected cost of the guarantee 208 to the service provider and the expected revenue 210 earned (by the service provider) by selling the guarantee. As such, in some examples, the guarantee module 148 may determine the expected outcome of purchasing the guarantee 212. That is, for each particular buyer/seller combination, what is the probability that the buyer will return the vehicle. In some examples, this probability may be fed into the expected cost of the guarantee 208 equation. Alternatively, or in addition, this probability may also be a factor in determining the product offering 214. For example, if there is a high likelihood that the buyer will return the vehicle, then the best product offering 214 (from the perspective of the service provider) may be a surcharge, a high guarantee acquisition fee, or both. Additionally, in some examples, the expected outcome of purchasing the guarantee 212 may influence the expected cost of the guarantee 208 in a linear fashion. For example, a higher probability of return may generate a higher expected cost to the service provider. However, in other examples, the relationship may be different and/or not linear at all.

Additionally, in some examples, the guarantee module 148 may be configured to determine the expected cost, to the service provider, if the vehicle is returned 216. Additionally, this determination may also affect the expected cost of the guarantee 208. Further, in some examples, the expected cost if returned 216 may be fed into a determination of the optimal price of the guarantee 218. That is, the optimal guarantee acquisition fee 218 may increase or decrease, at least in part, in response to increases or decreases in the expected cost if returned 216. However, other scenarios are possible. In some aspects, both the determined product offering 214 and/or the optimal guarantee acquisition fee 218 may help determine the expected revenue 210. Once the expected cost of the guarantee 208 and the expected revenue 210 are determined for a particular transaction, the guarantee module 148 may be able to determine the risk profile and/or the guarantee acquisition fee 206.

Various instructions, methods and techniques described herein may be considered in the general context of computer-executable instructions, such as program modules, executed by one or more computers or other devices. Generally, program modules include routines, programs, objects, components, data structures, etc., for performing particular tasks or implementing particular abstract data types. These program modules and the like may be executed as native code or may be downloaded and executed, such as in a virtual machine or other just-in-time compilation execution environment. Typically, the functionality of the program modules may be combined or distributed as desired in various embodiments. An implementation of these modules and techniques may be stored on some form of computer-readable storage media.

The example architectures and computing devices shown in FIGS. 1 and 2 are provided by way of example only. Numerous other operating environments, system architectures, and device configurations are possible. Accordingly, embodiments of the present disclosure should not be construed as being limited to any particular operating environment, system architecture, or device configuration.

### Illustrative Processes

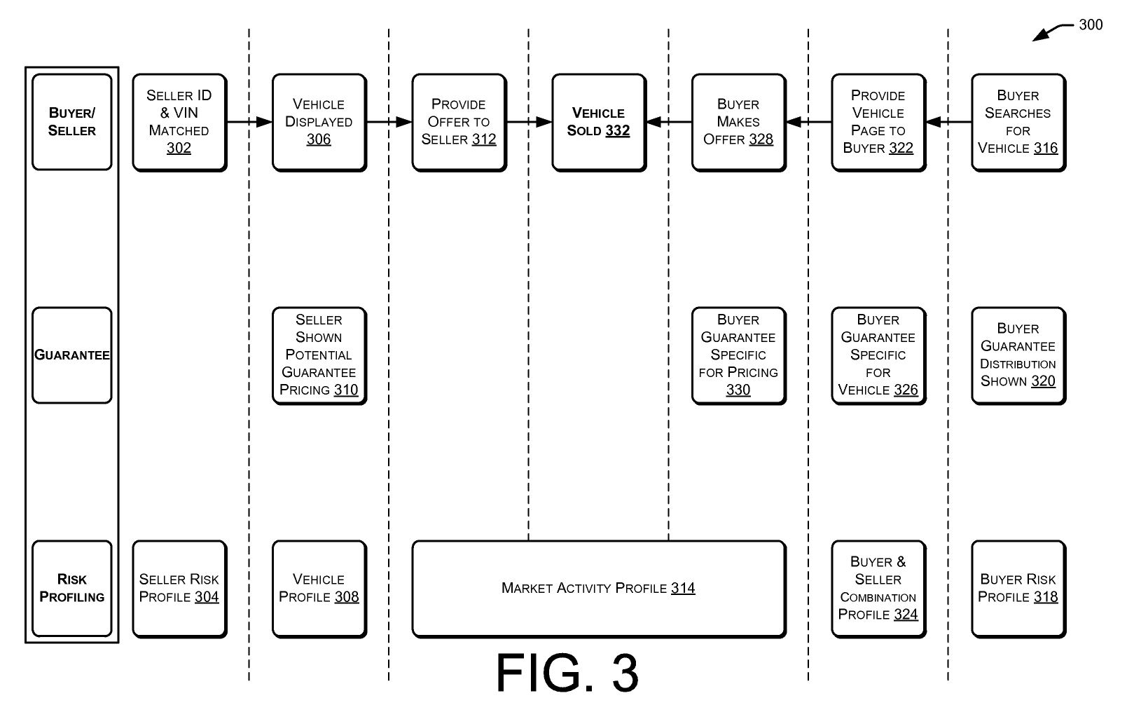

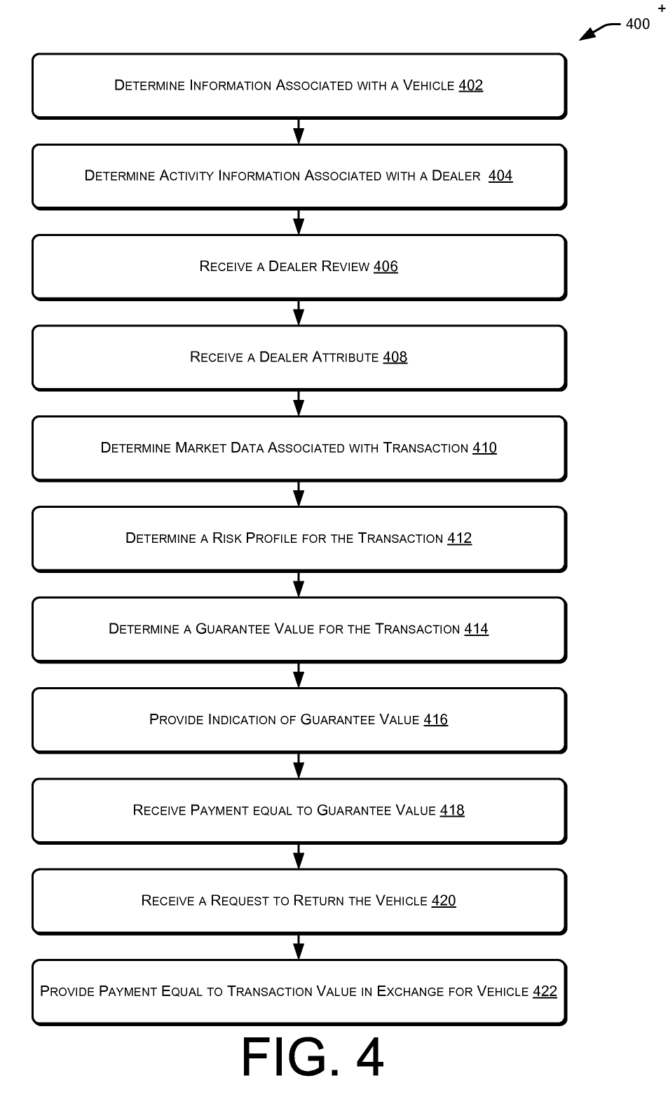

FIGS. 3 and 4 illustrate example flow diagrams showing processes 300 and 400, respectively, for providing a guarantee platform and/or a service for providing guarantee acquisition fees, as described above. These processes are illustrated as logical flow graphs, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

The process 300 may, but need not, be implemented by a computing device operated by a service provider, such as the service provider computers 110. In some aspects, the process 300 may begin by receiving and/or matching (previously received) seller IDs (e.g., of seller-dealers) and VIN numbers at block 302. In some examples, this matching provides an entry in a chart, a graph, a index, a list, or other data structure for referencing transactions. Additionally, as shown in the bottom row, labeled “Risk Profiling,” the service provider computers 110 may determine a seller risk profile at this stage, at block 304. That is, once the seller ID and VIN are matched (to correspond to a particular vehicle for sale), the guarantee module may determine a risk profile for the seller-dealer based, in part, on the seller activity, seller ratings, and/or seller attributes discussed above. At block 306, the process 300 may display the vehicle to potential buyer-dealers (e.g., as shown with reference to client application interface 106 of FIG. 1). At this stage, the guarantee module may determine the vehicle risk profile at block 308. This may be based, at least in part, on the price, the condition, the market value, and/or other information collected about the vehicle. Additionally, at this stage, the seller-dealer may be shown the potential guarantee pricing (e.g., one, more, and/or a range of guarantee acquisition fees that may be presented) at block 310. In some examples, this may occur prior to the potential buyer-dealer placing any purchase offers or bids.

The process 300 may then provide an offer to purchase the vehicle for a specified price (e.g., from a buyer-dealer) to the seller-dealer at block 312. At this stage, the market activity profile may be assessed at block 314. That is, the process 300 (e.g., the guarantee module 148) may dynamically update the guarantee acquisition fee to reflect the other factors listed above including, but not limited to, market activity, transaction activity, and/or market rates for the particular vehicle.

Alternatively, or in some cases concurrent with blocks 302 through 312, the process 300 may begin by receiving a request, from a potential buyer, to search for vehicle to purchase at block 316. At this stage, the process 300 may determine a buyer risk profile at block 318 based, at least in part, on buyer activity, buyer ratings, and/or buyer attributes. At block 320, the process 300 may display a buyer guarantee distribution to the buyer-dealer. That is, at the beginning of any transaction, or as part of displaying search results for potential vehicles to purchase, a distribution may be determined and/or provided. The distribution may give the buyer-dealer an idea of the range (e.g., the lowest and/or highest) of guarantee acquisition fees. In some examples, this information may be independent of the vehicles and/or the seller-dealers. However, in other examples, this distribution may be based mostly on the seller-dealer for each particular car. For example, the distribution for each seller-dealer may be different (for a given buyer-dealer) based on the seller-dealer's reputation (i.e., ratings, attributes, activity, etc.).

At block 322, a particular vehicle page may be provided to the buyer-dealer. In some examples, this may be in response to a request for a vehicle page from the buyer-dealer, and may be in real-time. At this stage, the process 300 may determine a buyer-dealer and seller-dealer combination risk profile at 324. That is, once the vehicle is selected, a buyer/seller pairing may be made, and a determination of the risk of return may change because the guarantee module 148 may have received or otherwise have stored collusion information and/or activity information associated with previous transactions between the particular buyer-dealer and seller-dealer. Additionally, at this stage, the buyer guarantee specific to the buyer and/or the buyer/seller pair may be provided to the buyer at block 326. Again, this guarantee acquisition fee may be specific to the vehicle based on factors including, but not limited to, vehicle price, transaction activity (e.g., other bids or offers for the same vehicle), and/or market activity and/or based on information associated with the buyer/seller pair including, but not limited to, buyer/seller activity, buyer/seller ratings, and/or buyer/seller attributes.

Additionally, in some examples, information about the buyer and seller individually may play into this determined guarantee acquisition fee (and maybe the guarantee cap amount). Further, this guarantee acquisition fee information may be presented in real-time. That is, when a buyer-dealer clicks on a car listing, one or more of the pieces of information presented could be the cost to purchase the guarantee for that vehicle (assuming that the seller-dealer hasn't already agreed to pay the guarantee acquisition cost). In some examples, when the seller-dealer chooses to purchase a guarantee for one or more buyer-dealers (e.g., to entice the buyer-dealer to purchase the vehicle from the seller-dealer), they may have the option of paying the guarantee acquisition fee in whole or in part. If in part, the platform may indicate that there is a guarantee up to a predetermine amount (e.g., x dollars), or the platform could show a guarantee acquisition fee which is reduced in an amount equivalent to the seller-dealer's contribution

The process 300 may then receive and/or provide an offer from the buyer to the seller at block 328. At this stage, similar to at block 312, the process 300 may begin, or continue, determining and/or utilizing market activity at block 314. The process 300 may also provide the buyer guarantee specific to the pricing of the vehicle at this stage at block 330. The process 300 may then end at block 332 when the vehicle is sold and/or the guarantee is purchased (i.e., all or part of the guarantee acquisition fee is paid by the buyer-dealer and/or the seller-dealer).

FIG. 4 illustrates a flow diagram showing the process 400 for providing a dynamic item-return guarantee acquisition fee. The process 400 may, but need not, be implemented by the service provider computer 110. In some aspects, the process 400 may begin by determining information associated with a vehicle at block 402. In some aspects, the determination may be performed by the at least one processor 132 of FIG. 1 and may be based on, or include, receiving (e.g., via the one or more input devices 140 of FIG. 1) vehicle information from a buyer-dealer, a seller-dealer, or a third-party service provider. In some cases, when received by a seller, the vehicle information may include a VIN, make, model, color, mileage, condition, etc. However, in other cases, when received by the buyer, the information may include search parameters for finding the vehicle within a database. Further, third-party service providers may provide market information, appraisal information, etc., associated with vehicles that may be offered for sale.

The process 400 may then determine activity information associated with a dealer at block 404. Again, this activity information may be determined based at least in part on receiving the information from outside sources. The process may also receive a dealer review at block 406. As noted above, dealer reviews may include ratings and/or textual reviews. The ratings may be utilized to determine an overall rating. Additionally, in some aspects, textual reviews may be mined, scrubbed, or otherwise reviewed for content. This information may also be utilized to determine an overall rating of a buyer and/or a seller (i.e., a dealer). At block 408, the process 400 may receive a dealer attribute (again, in some examples, via the one or more input devices 140 of FIG. 1). As noted above, dealer attributes may include, but are not limited to, dealer relationships, dealer transaction behavior, credit reports, etc. The process 400 may then determine market data associated with the transaction at block 410. Market data may include, but is not limited to, bids/offers placed for a particular vehicle, a number of bids/offers, the frequency and/or form of the bids/offers, comparisons of bids/offers to estimated market values, etc.

In some aspects, at block 412, the process 400 may determine a risk profile for the transaction. As noted above, each transaction may garner a different risk profile. In some aspects, the risk profile may be determined at block 412 based on one or more of previously described factors including, but not limited to, vehicle offer price, vehicle market price, dealer activity, dealer ratings, dealer attributes, and/or market activity. At block 414, the process 400 may determine a guarantee acquisition fee for the transaction. This guarantee acquisition fee (i.e., price of purchasing the guarantee) may be determined based at least in part on the risk profile determined at block 412. In some aspects, the process 400 may then provide an indication of the guarantee acquisition fee to the buyer-dealer and/or the seller-dealer at block 416. In some aspects, a potential guarantee acquisition fee may be provided to the seller-dealer when the vehicle is listed, at least for informational purposes. However, in other aspects, the guarantee acquisition fee may be provided to the buyer-dealer at several different instances throughout the process 400, and in some examples, may dynamically change as the process 400 flows.

At block 418, the process 400 may receive payment equal to the guarantee acquisition fee from the buyer-dealer of the vehicle. In this case, the buyer-dealer has chosen to purchase the guarantee which, of course, is not in any way required to purchase the desired vehicle. For example, the process 400 may determine guarantee acquisition fees and provide them to seller-dealers and potential buyer-dealers without any dealers (buyers in this example) purchasing the guarantee. In any event, in some non-limiting examples, the buyer-dealer (after purchasing and/or consummating purchase of a vehicle) may decide to return the vehicle and, in this case, the process 400 may then receive a request to return the vehicle at block 420. In some examples, the buyer-dealer may return the vehicle directly to the seller. However, in other examples, the process 400 may provide payment equal to the transaction amount (i.e., the value that the buyer-dealer initially paid the seller for the vehicle), equal to a portion (e.g., a percentage) of the transaction amount, and/or equal to a guaranteed value to the buyer-dealer in exchange for the vehicle at block 422. That is, in some examples, upon purchasing and redeeming the guarantee, a service provider (e.g., operating the service provider computers 110) may, in essence, purchase the vehicle from the buyer-dealer at the original purchase price (between the seller-dealer and the buyer-dealer), at a portion of the original purchase price (e.g., a percentage), at a capped (or non-capped) guarantee amount, and the service provider may retain the guarantee acquisition fee to offset any costs of the purchase from the original buyer-dealer. Further, either the buyer-dealer or the seller-dealer (in whole by either or in part by either) may purchase the guarantee so that vehicle may be returned.

Illustrative methods and systems for providing a dynamic, item-return guarantee are described above. Some or all of these systems and methods may, but need not, be implemented at least partially by architectures and/or flows such as those shown in FIGS. 1-4 above.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component.

Certain aspects of the disclosure are described above with reference to block and flow diagrams of systems, methods, apparatuses, and/or computer program products according to example embodiments. It will be understood that one or more blocks of the block diagrams and flow diagrams, and combinations of blocks in the block diagrams and the flow diagrams, respectively, may be implemented by execution of computer-executable program instructions. Likewise, some blocks of the block diagrams and flow diagrams may not necessarily need to be performed in the order presented, or may not necessarily need to be performed at all, according to some embodiments. Further, additional components and/or operations beyond those depicted in blocks of the block and/or flow diagrams may be present in certain embodiments.

Computer-executable program instructions may be loaded onto a special-purpose computer or other particular machine, a processor, or other programmable data processing apparatus to produce a particular machine, such that execution of the instructions on the computer, processor, or other programmable data processing apparatus causes one or more functions or operations specified in the flow diagrams to be performed. These computer program instructions may also be stored in a computer-readable storage medium (CRSM) that upon execution may direct a computer or other programmable data processing apparatus to function in a particular manner, such that the instructions stored in the computer-readable storage medium produce an article of manufacture including instruction means that implement one or more functions or operations specified in the flow diagrams. The computer program instructions may also be loaded onto a computer or other programmable data processing apparatus to cause a series of operational elements or steps to be performed on the computer or other programmable apparatus to produce a computer-implemented process.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Additional types of CRSM that may be present in any of the devices described herein may include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile disc (DVD) or other optical storage, magnetic cassettes, magnetic tape, magnetic disk storage or other magnetic storage devices, or any other medium which can be used to store the information and which can be accessed. Combinations of any of the above are also included within the scope of CRSM. Alternatively, computer-readable communication media (CRCM) may include computer-readable instructions, program modules, or other data transmitted within a data signal, such as a carrier wave, or other transmission. However, as used herein, CRSM does not include CRCM.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

That which is claimed:

1. A method, comprising:
determining, by at least one processor coupled to at least one memory, information associated with a vehicle;
determining, by the at least one processor, activity information associated with a dealer;
receiving, by the at least one processor, a dealer review or a dealer rating from a user computer;
receiving, by the at least one processor, a dealer attribute from at least one service provider computer;
determining, by the at least one processor, market data associated with a transaction involving the vehicle;
determining, by the at least one processor, a risk profile for the transaction involving the vehicle between a buyer-dealer and a seller-dealer, and the risk profile being based at least in part on at least two of the information associated with the vehicle, the activity information associated with the dealer, the dealer review, the dealer attribute, or the market data associated with the transaction involving the vehicle; and
determining, by the at least one processor and based at least in part on the risk profile, a guarantee acquisition fee for the transaction involving the vehicle.

2. The method of claim 1, further comprising:
providing, to at least one of the buyer-dealer or the seller-dealer, an indication of the guarantee acquisition fee for the transaction involving the vehicle; and
receiving, from the buyer-dealer, payment equal to the guarantee acquisition fee when the buyer-dealer completes the transaction involving the vehicle with the seller-dealer.

3. The method of claim 2, further comprising:
receiving, from the buyer-dealer, a request to return the vehicle; and
providing, to the buyer-dealer, payment equal to or a predetermined portion of a purchase price associated with the completed transaction in exchange for the vehicle.

4. One or more computer-readable media storing computer-executable instructions that, when executed by at least one processor, configure the at least one processor to perform operations comprising:
determining information associated with an item for sale;
determining activity information associated with a dealer, wherein the dealer comprises at least one of a buyer-dealer or a seller-dealer;
receiving a dealer review;
determining, based at least in part on at least two of the information associated with the item, the activity information associated with the dealer, or the dealer review, a risk profile for a transaction involving the item between the buyer-dealer and the seller-dealer; and
determining, based at least in part on the risk profile, a guarantee acquisition fee for the transaction involving the item.

5. The one or more computer-readable media of claim 4, the operations further comprising:
providing, to at least one of the buyer-dealer or the seller-dealer, an indication of the guarantee acquisition fee for the transaction involving the item; and
receiving, from one of the buyer-dealer or seller-dealer, payment equal to the guarantee acquisition fee.

6. The one or more computer-readable media of claim 4, the operations further comprising:
receiving, from the buyer-dealer, a request to return the item; and
providing, to the buyer-dealer, payment equal to or a predetermined portion of a purchase price associated with the completed transaction in exchange for the item.

7. A system, comprising:
at least one memory that stores computer-executable instructions;
at least one processor configured to access the at least one memory, wherein the at least one processor is configured to execute the computer-executable instructions to:
determine information associated with an item;
determine activity information associated with a dealer, wherein the dealer comprises at least one of a buyer-dealer or a seller-dealer; and
determine, based at least in part on the information associated with the item and the activity information associated with the dealer, a guarantee acquisition fee for a transaction involving the item between the buyer-dealer and the seller-dealer.

8. The system of claim 7, wherein the at least one processor is further configured to execute the computer-executable instructions to:
provide, to at least one of the buyer-dealer or the seller-dealer, an indication of the guarantee acquisition fee for the transaction involving the item; and
receive, from the buyer-dealer or seller-dealer, payment equal to the guarantee acquisition fee when the buyer-dealer completes the transaction involving the item with the seller-dealer.

9. The system of claim 7, wherein the at least one processor is further configured to execute the computer-executable instructions to:
receive, from the buyer-dealer, a request to return the item; and
provide, to the buyer-dealer, payment equal to or a predetermined portion of a purchase price associated with the completed transaction in exchange for the item.

10. The system of claim 7, wherein the information associated with the item comprises at least one of a market price for the item, a price of an offer to purchase the item, a region within which the item is located, a mileage of the item, or a condition of the item.

11. The system of claim 10, wherein the at least one processor is further configured to execute the computer-executable instructions to update the guarantee acquisition fee for the transaction based at least in part on a change in the price of the offer to purchase the item.

12. The system of claim 10, wherein the at least one processor is further configured to execute the computer-executable instructions to determine the guarantee acquisition fee for the transaction based at least in part on a difference between the market price for the item and the price of the offer to purchase the item.

13. The system of claim 7, wherein the determination of the information associated with the item comprises at least one of receiving the information from the seller-dealer, receiving the information from a third-party appraiser, or receiving, from the buyer-dealer, an offer to purchase the item.

14. The system of claim 7, wherein the activity information associated with the dealer comprises at least one of an arbitration rate associated with the buyer-dealer or the seller-dealer, a return rate associated with the buyer-dealer or the seller-dealer, a number of transactions completed by the buyer-dealer, a number of transactions completed by the seller-dealer, or a number of items returned due to false reporting associated with the seller-dealer.

15. The system of claim 14, wherein the false reporting comprises an indication, by the seller-dealer, of a mileage or condition of the item that is untrue.

16. The system of claim 14, wherein the at least one processor is further configured to execute the computer-executable instructions to update the guarantee acquisition fee for the transaction based at least in part on a change in the activity information associated with the dealer.

17. The system of claim 7, wherein the determination of the activity information associated with the dealer comprises at least one of retrieving the activity information from the at least one memory or receiving the activity information from a third-party service provider.

18. The system of claim 7, wherein the at least one processor is further configured to execute the computer-executable instructions to receive, from a user computer, a dealer review.

19. The system of claim 18, wherein the determination of the guarantee acquisition fee for the transaction involving the item between the buyer-dealer and the seller-dealer is further based at least in part on the dealer review.

20. The system of claim 18, wherein the user computer comprises a computer associated with the seller-dealer or a computer associated with the buyer-dealer, and the dealer review comprises at least one of a rating associated with another user or a textual review associated with another user.

21. The system of claim 20, wherein the at least one processor is further configured to execute the computer-executable instructions to determine a review score associated with the textual review based at least in part on mining the textual review for at least one of a key word within the textual review, a number of key words within the textual review, a tone of the textual review, a depth of the textual review, a number of filler words within the textual review, or a number of words with content associated with the item, and wherein the at least one processor is further configured to execute the computer-executable instructions to determine an overall review score for a buyer-dealer or a seller-dealer based at least in part on the review score associated with the textual review.

22. The system of claim 7, wherein the at least one processor is further configured to execute the computer-executable instructions to receive, from at least one service provider computer, a dealer attribute.

23. The system of claim 22, wherein the determination of the guarantee acquisition fee for the transaction involving the item between the buyer-dealer and the seller-dealer is further based at least in part on the dealer attribute.

24. The system of claim 22, wherein the dealer attribute comprises a relationship with one or more other dealers, a transaction pattern of the dealer, a vehicle on a lot of the dealer, a number of vehicles on a lot of the dealer, credit information associated with the dealer, or account information associated with the dealer and the at least one service provider computer.

25. The system of claim 7, wherein the at least one processor is further configured to execute the computer-executable instructions to determine market data associated with a transaction involving the item.

26. The system of claim 25, wherein the determination of the guarantee acquisition fee for the transaction involving the item between the buyer-dealer and the seller-dealer is further based at least in part on the market data.

27. The system of claim 25, wherein the market data comprises a method associated with an offer to purchase the item, a number of offers to purchase the item, an amount of time an item is viewed via a Web interface, a frequency of offers to purchase the item, or a number of buyer-dealers that make offers to purchase the item.

28. The system of claim 7, wherein the at least one processor is further configured to execute the computer-executable instructions to determine, based at least in part on the information associated with the item and the information associated with the seller-dealer, an offer price for the item, wherein the offer price comprises an immediate purchase price for the item or a money advance for the item prior to selling the item to the buyer-dealer.

29. The method of claim 28, wherein the offer price is based at least in part on a predicted sales price of the item at auction or elsewhere.

30. A method, comprising:
receiving, from a third-party service by at least one processor coupled to at least on memory, a request for a guarantee amount or a guarantee acquisition fee associated with a transaction;
determining, by the at least one processor, a risk profile for the transaction and/or the guarantee amount for the transaction, the risk profile being based at least in part on at least two of information associated with a vehicle, activity information associated with a dealer, a dealer review, a dealer attribute, or market data associated with the transaction;
determining, by the at least one processor and based at least in part on the risk profile, the guarantee acquisition fee for the transaction; and
providing, by the at least one processor, the guarantee acquisition fee to the third-party service.
